(19) United States
(12) Patent Application Publication
(10) Pub. No.: US 2024/0099437 A1
(43) Pub. Date: Mar. 28, 2024

(54) SYSTEM AND METHOD FOR MAGNETIC LATCHING

(71) Applicant: Christopher Paul Curtis, La Mesa, CA (US)

(72) Inventor: Christopher Paul Curtis, La Mesa, CA (US)

(21) Appl. No.: 17/952,122

(22) Filed: Sep. 23, 2022

(51) Int. Cl. A45C 13/10; A44B 99/00; F16B 1/00; F16M 13/02

(52) U.S. Cl. CPC A45C 13/1069; A44B 99/00; F16B 1/00; F16M 13/02; A44D 2203/00; F16B 2001/0035

(57) ABSTRACT

A system and method for magnetic latching that can include a male fastener and a female fastener. The male fastener and female fastener can have lateral motion restrictors that restrict motion of the male and female fasteners relative to each other when the fasteners are latched together. At least one magnet in each fastener can provide attractive force that latches the two fasteners together.

### FIELD OF THE INVENTION

This application relates to magnets, and more particularly, to magnetic latches and magnetic attaching devices.

### BACKGROUND OF THE INVENTION

Mankind has been harnessing the power of magnets for millennia. Many uses of magnets in modern life include attracting two non-magnetic objects together by attaching magnets to those non-magnetic objects. Some examples of this include installing a magnet on the flap, or lid, of a purse, with another magnet on the body of the purse, so that the magnets can attract each other and hold the flap of the purse to the body of the purse, thereby keeping the purse closed. Other embodiments include wireless controllers that can be held to a wall, the side of equipment, or in cradles with magnets, and portable lights that can be held to a wall or other areas using magnets. Magnets have been used to hold two things together, and used to hold things closed, in myriad applications.

However, there are a number of shortcomings to using magnets to hold things closed or hold things together. Depending on the strength of the magnets, it may be very difficult to pull two magnets in opposite directions away from each other, however, it may be substantially easier to slide those two magnets so that the two magnet surfaces rub against each other until the two magnets have been at least partially separated. Once the magnets are at least partially separated, it is easier to pull them apart in opposite directions, and it may also be easier to continue slide the magnets along each other until they are completely separated. FIG. 1 shows two square magnets in engagement with each other. Top magnet 102 has an N pole on its top magnet surface 104, and an S pole on its bottom magnet surface. Bottom magnet 112 has an S pole on its top surface, and an N pole on is bottom surface. Because the S pole of one magnet is engaged with the N pole of the other magnet, the magnetic attraction between the two magnets is holding the magnets together. Depending on the strength of the magnets, it may be very difficult to pull the magnets apart from each other in opposite directions along axis Z. Movement in opposite directions along the Z axis can also be referred to as movement in the brute force direction. However, it is much easier to slide the magnets along each other and pull them in opposite directions along axis Y or X. This sliding along axis X and/or Y can also be referred to as the movement in the direction of sheer force. The magnets are easier to move in the X and/or Y direction because movement in opposite directions along axis X or Y does not require the magnets to fully separate, and yet movement in those directions does decrease the contact between the two magnets, along with decreasing the attraction between the two magnets, thereby making them easier to fully separate. After the magnets have been at least partially separated in a sheer force direction, it becomes substantially easier to separate them in the brute force direction. Although the magnets may have a strong attraction in the Z axis direction when they are fully engaged, partially separating them by sliding the magnets along the X and/or Y direction can make them substantially easier to separate in any direction.

This ease of separating even the strongest of magnets so long as they can be moved first in a lateral direction relative to each other makes magnets much less effective in a number of applications. This is especially true in environments where two objects being held together by magnets are in motion, or shaking, or otherwise exposed to additional outside forces that may jostle the magnets in a lateral, X and/or Y direction. The jostling of magnets in a lateral direction may cause the two magnets to lose contact with each other, thereby resulting in the two objects that were once held together by magnets becoming free of each other. It would be desirable to have a magnetic latch that restricts the lateral movement in at least one direction so that the strength in the Z direction of the magnets is maintained, and the magnets are not decreasing their attraction by slipping along the restricted-movement axis.

### SUMMARY OF THE INVENTION

The present disclosure overcomes disadvantages of the prior art by providing a system and method for magnetic latching that utilizes the brute strength of magnets in the Z direction while restricting the movement of the magnets relative to each other in the X direction. This restriction of movement in the X direction limits the ability of the magnets to decrease their contact by sliding relative to each other, which prevents a decrease of strength in the Z direction. Various embodiments of the present disclosure allow lateral slippage along only the single Y axis, while forces in any other lateral direction do not result in slippage. This maintains the magnets in the strongest orientation, directly aligned with each other, unless lateral force is applied along the Y axis. However, application of force along the Y axis can be used intentionally to decrease the contact between the magnets making them easier to separate in the Z direction.

In an embodiment, a magnetic latch can include a male fastener and a female fastener. The male fastener can have a first lateral motion restrictor and at least one magnet, with the at least one magnet having a first pole exposed in a latching direction and a second pole facing away from a latching direction. The female fastener can have a second lateral motion restrictor and at least one magnet, with the at least one magnet having a second pole exposed in a latching direction and a first pole facing away from a latching direction.

In various embodiments, the first lateral motion restrictor can be an elongated ridge that rises upwards relative to the at least one magnet of the male fastener and can extend parallel to the at least one magnet of the male fastener. The second lateral motion restrictor can be an elongated trench that can be sunken downwards relative to the at least one magnet of the female fastener and can extend parallel to the at least one magnet of the female fastener. In various embodiments, the at least one magnet of the male fastener can include at least two magnets, and a first one of the at least two magnets can be on a first side of the first lateral motion restrictor and a second one of the at least two magnets can be on a second side of the first lateral motion restrictor. The at least one magnet of the female fastener can include at least two magnets, wherein a first one of the at least two magnets can be on a first side of the second lateral motion restrictor and a second one of the at least two magnets can be on a second side of the second lateral motion restrictor. The second lateral motion restrictor can be an elongated trench that extends through the entire length of the female fastener. When the male fastener and the female fastener are in engagement with each other, the male fastener and the female fastener cannot move relative to each other in the direction of an X axis, and the male fastener and the female fastener can move relative to each other in the direction of a Y axis and a Z axis. When the male fastener and the female fastener are in engagement with each other, the first lateral motion restrictor and the second lateral motion restrictor can be in engagement with each other. When the first lateral motion restrictor and the second lateral motion restrictor are in engagement with each other, the first lateral motion restrictor and the second lateral motion restrictor restrict movement of the male fastener and the female fastener relative to each other in the direction of the X axis, and wherein when the first lateral motion restrictor and the second lateral motion restrictor are in engagement with each other, the first lateral motion restrictor and the second lateral motion restrictor may not restrict the movement of the male fastener and the female fastener relative to each other in the direction of the Y axis and Z axis.

### BRIEF DESCRIPTION OF THE DRAWINGS

The invention description below refers to the accompanying drawings, of which:

FIG. 1 is a perspective view of two square magnets engaged with each other, according to an illustrative embodiment;

FIG. 2 is an exploded perspective view of female and male fasteners of a magnetic latch, according to an illustrative embodiment;

FIG. 3A is a top view of the female fastener of the magnetic latch of FIG. 2, according to an illustrative embodiment;

FIG. 3B is a top view of the male fastener of the magnetic latch of FIG. 2, according to an illustrative embodiment;

FIG. 4 is an exploded end view of the magnetic latch of FIG. 2, showing the male fastener and the female fastener in position to become engaged by moving towards each other in the Z direction; according to an illustrative embodiment;

FIG. 5A is an exploded side view of the magnetic latch of FIG. 2, showing the male fastener and the female fastener in position to become engaged by moving towards each other in the Z direction; according to an illustrative embodiment;

FIG. 5B is a side view of the magnetic latch of FIG. 2, showing the male fastener and the female fastener in a fully engaged conformation, according to an illustrative embodiment;

FIG. 5C is a side view of the magnetic latch of FIG. 2, showing the male fastener and the female fastener in a partially engaged conformation, according to an illustrative embodiment;

FIG. 6A is an end view of the ridge structure of the male fastener of the magnetic latch of FIG. 2, according to an illustrative embodiment;

FIGS. 6B-6F are an end views of various possible ridge structures for male fasteners of a magnetic latch, according to various illustrative embodiments;

FIG. 7A is a perspective view of a female fastener of a magnetic latch with a single magnet, according to an illustrative embodiment;

FIG. 7B is a perspective view of a male fastener of a magnetic latch with a single magnet, according to an illustrative embodiment;

FIG. 7C is a top view of a female fastener of a magnetic latch with a single magnet, according to an illustrative embodiment;

FIG. 7D is a top view of a male fastener of a magnetic latch with a single magnet, according to an illustrative embodiment;

FIG. 7E is an exploded end view of the magnetic latch of FIGS. 7A and 7B, showing the male fastener and the female fastener in position to become engaged by moving in the Z direction; according to an illustrative embodiment;

FIG. 7F is an exploded end view of a magnetic latch with X+ lateral motion inhibitors, according to an illustrative embodiment;

FIG. 7G is a perspective view of a fastener shown in FIG. 7F with X+ lateral motion inhibitors, according to an illustrative embodiment;

FIG. 8A is a perspective view of a female fastener of a modular magnetic latch, according to an illustrative embodiment;

FIG. 8B is a perspective view of a male fastener of a modular magnetic latch, according to an illustrative embodiment;

FIG. 8C is an exploded perspective view of a modular latch, according to an illustrative embodiment;

FIG. 9A is a top view of an elongated female fastener of a magnetic latch, according to an illustrative embodiment;

FIG. 9B is a top view of an elongated male fastener of a magnetic latch, according to an illustrative embodiment;

FIG. 10A is an exploded cross section view of the male fastener shown in FIG. 3B, taken along cross section line 10A-10A showing magnets in position to be installed from above, according to an illustrative embodiment;

FIG. 10B is an exploded cross section view of the female fastener shown in FIG. 3A, taken along cross section line 10B-10B, showing magnets in position to be installed from above, according to an illustrative embodiment;

FIG. 10C is a bottom view of a fastener shown in FIG. 3A with the magnets installed from the top, according to an illustrative embodiment;

FIG. 11A is a bottom view of a fastener with the magnets installed from the bottom, according to an illustrative embodiment;

FIG. 11B is an exploded cross section view of a male fastener, taken along cross section line 11B-11B of FIG. 11A, showing magnets in position to be installed from below, according to an illustrative embodiment;

FIG. 11C is an exploded cross section view of a female fastener, taken along cross section line 11B-11B of FIG. 11A, showing magnets in position to be installed from below, according to an illustrative embodiment;

FIG. 11D is a perspective view of the top of a male fastener with a bezel holding in a magnet that was installed from the back, according to an illustrative embodiment;

FIG. 12A is a perspective view of magnetic latches installed on storage pouches for use on a belt, according to an illustrative embodiment;

FIG. 12B is a perspective view of the storage pouches of FIG. 12A, shown in a closed conformation, according to an illustrative embodiment;

FIG. 13A is a perspective view of a modular latch in use in a military application for supporting a weapon on the chest of a user, according to an illustrative embodiment; and

FIG. 13B is a perspective view of the modular latch of FIG. 13A being used to hold the weapon without a strap, according to an illustrative embodiment.

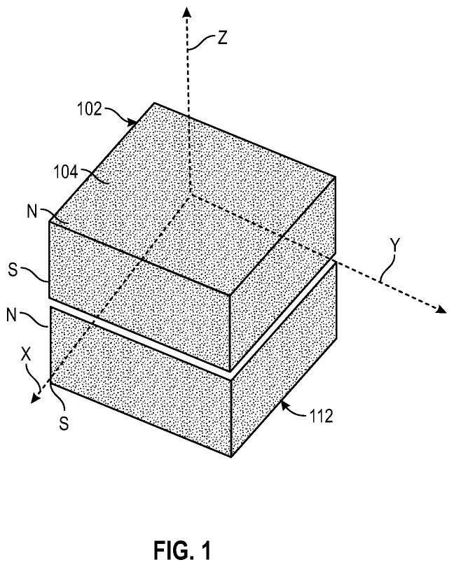

### DETAILED DESCRIPTION

There are a great many possible implementations of the invention, too many to describe herein. Some possible implementations that are presently preferred are described below. It cannot be emphasized too strongly, however, that these are descriptions of implementations of the invention, and not descriptions of the invention, which is not limited to the detailed implementations described in this section but is described in broader terms in the claims.

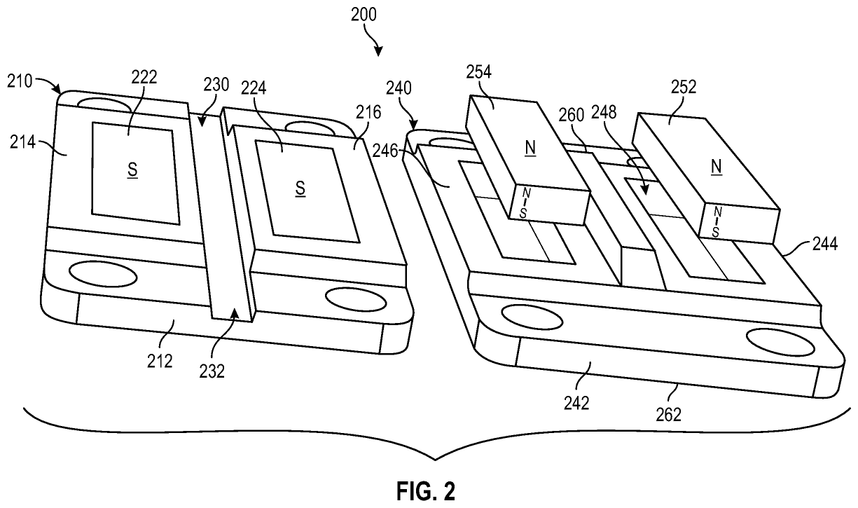

FIG. 2 is an exploded perspective view of female and male fasteners of a magnetic latch, also referred to as male and female fasteners, according to an illustrative embodiment. A magnetic latch 200 of the present disclosure can have a female fastener 210 and a male fastener 240. Female fastener 210 can have a female fastener body 212, and male fastener 240 can have a male fastener body 242. The fastener bodies 212 and 242 can be non-magnetic and can be made from various plastics, non-magnetic metals, wood, or other non-magnetic materials. A fastener body can hold one or more magnets and can have one or more structural latching features.

Female fastener 210 can have a first magnet 216 and a second magnet 218, however, larger numbers and smaller numbers of magnets are specifically contemplated, as will be discussed more fully below. Magnets 216 and 218 can be bar magnets with an S pole running along the top of the bar, and an N pole running along the bottom of the bar. These magnets can be various types of magnets, including neodynium magnets, samarium cobalt magnets, alnico magnets, and ferrite magnets. Female fastener 210 can have magnets 222 and 224 arranged with the S pole facing outwards, and the N pole facing inwards, within the female fastener body 212, so that only the S pole is exposed on the magnet faces 214 and 216 of the female fastener 210.

Conversely, the male fastener 240 can have magnets 252 and 254 arranged with the N pole facing outwards and the S pole facing inwards, within the male fastener body 442, so that only the N pole is exposed on the magnet faces 244 and 246 of the male fastener 240. It should be clear that in various embodiments, the female fastener can have the N pole facing outwards and the male fastener can have the S pole facing outwards, however, in the interest of providing a clear and easy to read description, throughout the rest of this document it will be described that the female fastener has the S pole facing outwards and the male fastener has the N pole facing outwards.

In various embodiments, a female fastener can have an N pole exposed on one face and an S pole exposed on another face, and the male fastener can correspondingly have an S pole on one face and an N pole on another face. This may be useful in embodiments where the orientation of the male fastener relative to the female fastener is important and requires that they only orient in one direction and orientation in order to latch together. However, unless stated otherwise, in the interest of providing a clear and easy to read description, throughout the rest of this document it will be described that the female fastener has the S pole facing outwards and the male fastener has the N pole facing outwards.

Both the male fastener and the female fastener can have one or more magnet faces. The female fastener 210 can have a first magnet face 214 and a second magnet face 216. As shown in FIG. 2, these magnet faces 214 and 216 are in the same plane, however, in various embodiments the two magnet faces may be at an angle to each other, may be parallel and offset, or various other arrangements. The male fastener 240 can also have a first magnet face 244 and a second magnet face 246. These magnet faces 244 and 246 can be in the same plane, or can be at an angle to each other, or parallel and offset, or various other arrangements.

Magnets 222, 224 can be part of female magnet faces 214, 216, and magnets 252, 254 can be part of male magnet faces 244, 246. In various embodiments, a magnet 222 can be flush with a magnet face 214 or can be inset below the face 214. Each magnet face can be a surface that is adapted to mate with a corresponding magnet face on the opposite fastener. Each magnet face can be larger than the surface of the magnet and the corresponding magnet surfaces on the female and male fasteners can be adapted to be in contact with each other when the magnetic latch 200 is latched.

Male fastener 240 is shown in an exploded state, with the magnets 252 and 254 in position over the magnet wells 248. Magnets 252 and 254 can be inserted into the magnet wells 248 during assembly of the latch 200 and the magnet can be adhered to, or otherwise attached to the fastener body. With magnets attached to the fastener bodies, the magnetic surface of the magnets causes a magnet face of a male latch to be attracted to a magnet face of a female latch.

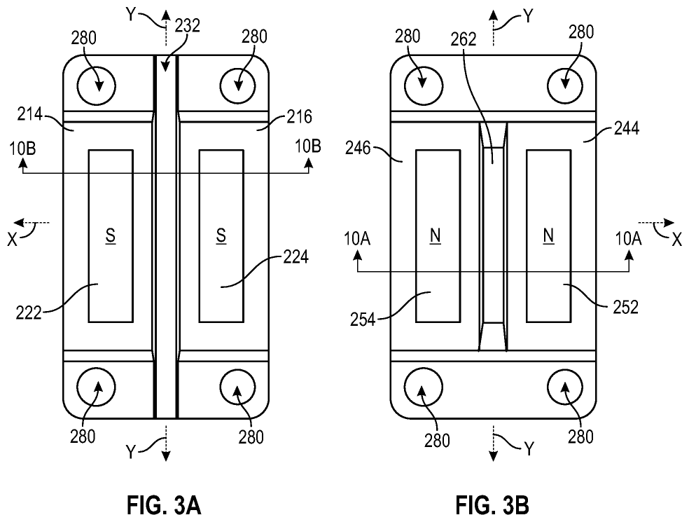

FIG. 3A is a top view of the female fastener of the magnetic latch of FIG. 2, according to an illustrative embodiment, and FIG. 3B is a top view of the male fastener of the magnetic latch of FIG. 2, according to an illustrative embodiment. Turning to FIGS. 2, 3A, and 3B, the female fastener can have a first lateral motion restrictor 230, and the male fastener can have a second lateral motion restrictor 260. The first lateral motion restrictor 230 can be a female trench 232, and the second lateral motion restrictor 260 can be a male ridge 262. When the magnetic latch is in a latched conformation, the magnet faces 214, 216 of the female fastener 210 can be in engagement with the magnet faces 244, 246 of the male fastener, and the magnets in the magnet faces cause the two fasteners to be attracted to each other. When the magnetic latch is in a latched conformation, first lateral motion restrictor 230 can be in engagement with the second lateral motion restrictor 260. When the two lateral motion restrictors 230 and 260 are in engagement with each other, the female fastener and the male fastener are restricted in their lateral movements so that they can only move in in the Y direction, but cannot move in the X direction while the magnet faces are in engagement with each other. When the ridge 262 is within the trench 232, the fasteners cannot slide apart from each other in the X direction until they are separated by being pulled apart from each other in either the Z direction or the Y direction.

The ridge can extend upwards from the fastener body. In various embodiments, the ridge can rise above at least one magnet face. Similarly, the trench can extend downward into the fastener body. In various embodiments, the trench can extend below at least one magnet face. In various embodiments, the ridge 262 can extend along the Y axis. The ridge can run parallel with, and lie alongside and between two magnets 254, 252. The magnets can have the same polarity extending along the Y axis and along the length of the ridge. The magnets of the male fastener remain in a fixed location and orientation relative to the lateral motion restrictor of that male fastener at all times. Similarly, the trench 232 can extend along the Y axis, and run parallel with and between two magnets 222, 224, and the magnets can have the same polarity extending along the Y axis and along the length of the trench. The magnets of the female fastener remain in a fixed location and orientation relative to the lateral motion restrictor of that female fastener at all times.

Female fasteners 210 and male fasteners 240 can have utility holes 280. Utility holes 280 can be used to mount the fasteners to a surface to be fastened, such as a pouch and the flap on the pouch. Utility holes 280 can be used to connect multiple fasteners together in series. Utility holes 280 can have shoelaces threaded through them. Various uses are possible, including connecting a fastener to another object.

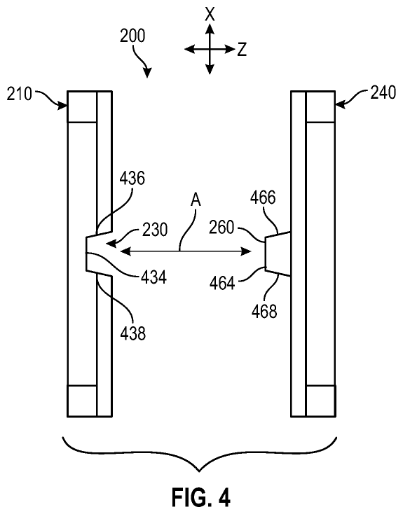

FIG. 4 is an exploded end view of the magnetic latch of FIG. 2, showing the male fastener and the female fastener in position to become engaged by moving towards each other in the Z direction; according to an illustrative embodiment. Turning to FIGS. 3A, 3B, and 4, the lateral motion restrictors 230 and 260 are sized and shaped to engage with each other so that the male and female fasteners 210, 240 cannot move relative to each other in the X direction after the fasteners are brought into engagement by moving along arrow A. In various embodiments, the lateral motion restrictors, such as a ridge and trench, can be non-magnetic and can be integral parts of non-magnetic fastener bodies. The magnets within the non-magnetic fastener bodies draw the fastener bodies together into the latched conformation, resulting in the non-magnetic lateral motion restrictors coming into engagement with each other and preventing motion of the fastener bodies relative to each other in the X direction. When the lateral motion restrictors are non-magnetic, the male and female fasteners are able to slide more easily relative to each other along the Y axis while still using strong magnets embedded in the fastener bodies that are capable of supporting heavy weights.

In various embodiments, the lateral motion restrictors, such as a ridge 262 and a trench 232, can have features that extend lengthwise along the Y axis and are designed to engage with the corresponding lateral motion restrictors. By way of non-limiting example, a trench can have a bottom floor 434 and two sidewalls 436 and 438, and a ridge can have a corresponding top surface 464, and two sidewalls 466 and 468. These lengthwise features of the first lateral motion restrictor, such as a trench, can be in contact with the corresponding features of the second lateral motion restrictor, such as a ridge 262, and can remain in contact as the two fasteners move laterally relative to each other in the Y direction. Sidewall 466 can be in contact with sidewall 436 and/or sidewall 468 and be in contact with sidewall 438. So long as the female lateral motion restrictor 230 is in engagement with the male lateral motion restrictor 260, the two fasteners cannot move apart from each other in the X direction relative to each other.

Because the lateral motion restrictor restricts motion along the X axis, the latch can be used to suspend heavy objects. One fastener can be affixed to the object to be suspended, and the other fastener can be affixed to the item or surface the object is to be suspended from. If the fasteners are installed with the X axis aligned with the force of gravity, the lateral motion restrictors will prevent the suspended object from moving in the direction of the force of gravity. Put another way, if the lateral motion restrictors are installed with the Y axis parallel to the ground, the lateral motion restrictors will prevent the suspended object from shifting towards the ground.

The two sidewalls 466 and 468 can be sloped so that the lean towards each other, farther apart near the body and closer together near the top surface. This allows the fasteners to be brought into imperfect alignment with each other and still result in engagement of the latch into the latched conformation. Because the top portion of the ridge is narrower than the opening of the trench, the ridge can still begin to enter the trench despite imperfect alignment. As the magnets attract each other, the ridge is pulled into the trench and the fasteners are shifted into alignment.

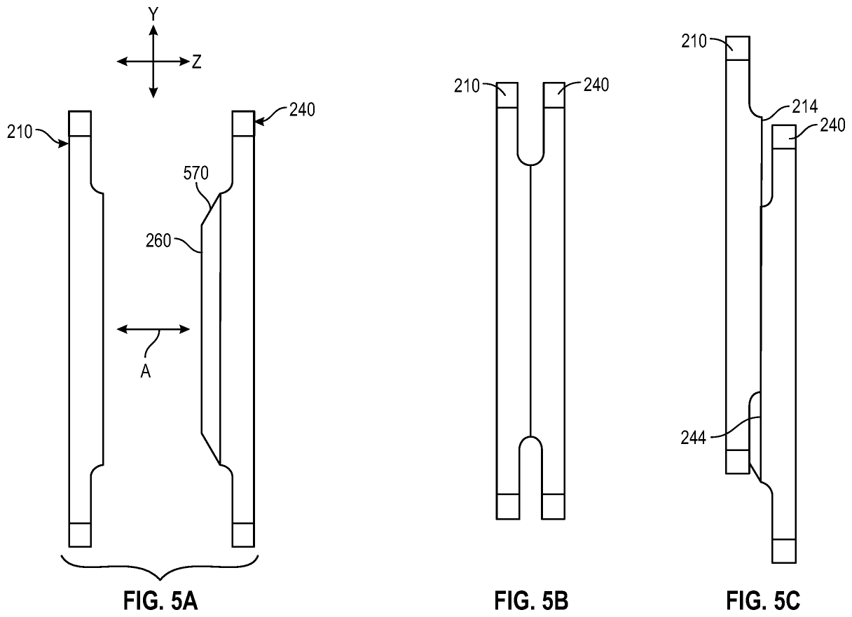

Trench 232 has a floor and sidewalls that extend all the way from one end of the fastener body to the other end of the fastener body. Put another way, the trench 232 can extend all the way through the entire length of the female fastener body. This allows the male fastener and female fastener to be brought into partial engagement with each other, so that the magnet faces are in partial engagement. Partial engagement of the magnet faces means that a portion of a female face, such as 214, can be in contact with a portion of a male face, such as 244, although the two magnets 222 and 252 are not perfectly aligned above one another but are instead offset along the Y axis, explained more fully below in regard to FIG. 5C. In a state of partial engagement, the ridge of the male fastener may extend beyond the female latch body.

FIG. 5A is an exploded side view of the magnetic latch of FIG. 2, showing the male fastener and the female fastener in position to become engaged by moving towards each other in the Z direction; according to an illustrative embodiment. In an embodiment, the ridge 262 may have a slide such as a curved or sloped front 570 that helps to ease the ridge 262 into the trench when the two fasteners are brought into engagement along the Y axis. Any slight misalignment of the two fasteners can be corrected by, for example, the sloped front 570 and sloped sidewalls helping the misaligned fasteners begin to engage while they are slightly misaligned, and then shift into alignment as they are pulled together.

FIG. 5B is a side view of the magnetic latch of FIG. 2, showing the male fastener and the female fastener in a fully engaged conformation, according to an illustrative embodiment. As shown in FIG. 5B, the ridge of the male fastener 240 is fully aligned with and engaged within the trench of the female fastener 210. In this latched conformation, the magnets can slide relative to each other along the Y axis, and can be pulled apart along the Z axis, but they cannot be pulled apart along the X axis unless they are separated first along Z axis or the Y axis.

FIG. 5C is a side view of the magnetic latch of FIG. 2, showing the male fastener and the female fastener in a partially engaged conformation, according to an illustrative embodiment. The fasteners 210 and 240 can be in partial engagement with magnet face 214 partially in contact with magnet face 244. In the partially engaged conformation, the magnets are attracting each other and are providing a force that biases the two fasteners into the fully engaged conformation shown in FIG. 5B. The fasteners can be brought into partial engagement, and the magnets will pull the fasteners into the fully engaged conformation unless there is an opposing force.

The fasteners can be fully engaged, as shown in FIG. 5B, and can be shifted along the Y axis into the partially engaged conformation shown in FIG. 5C. In a partially engaged conformation, the latch remains latched, with the magnets pulling the two fasteners towards each other and resisting movement in the Z direction. In the partially engaged conformation of the latch, the lateral motion restrictors are also partially engaged. When the lateral motion restrictors are partially engaged, they resist lateral motion and prevent the latch from being separated in the X direction. From the partially engaged conformation, the fasteners can slide towards each other along the Y axis if there is no opposing force, or can be further separated along the Y axis with the application of additional force along the Y axis. The S poles of the magnet(s) of the female fastener are in a sliding engagement with the N poles of the magnet(s) of the male fastener. Regardless of whether the male and female fasteners are sliding relative to each other in increasing or decreasing engagement, the S pole and the N pole can remain in engagement while the fasteners are sliding relative to each other. The S pole and the N pole can remain in engagement throughout the sliding, and can remain in engagement until the fasteners are separated. Similarly, the lateral motion restrictors can slide relative to each other and remain in engagement until the fasteners are separated.

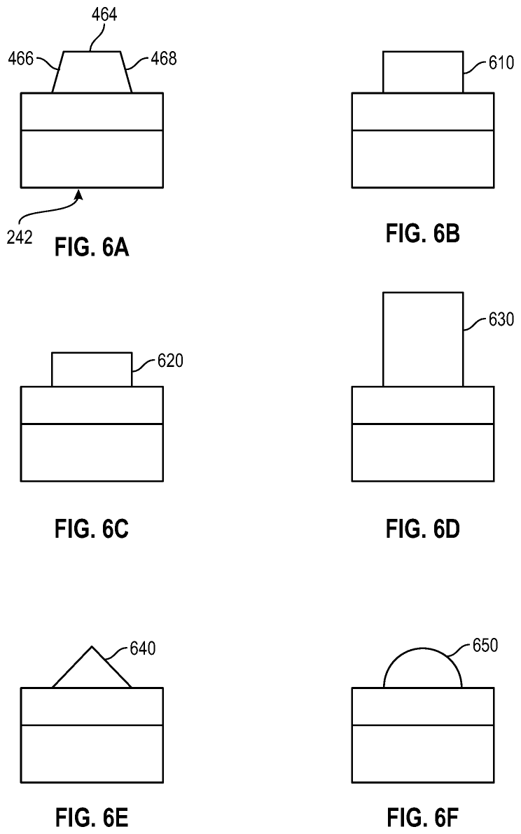

FIG. 6A is an end view of the ridge structure of the male fastener of the magnetic latch of FIG. 2, according to an illustrative embodiment. As shown in FIG. 6A, the sidewalls 466 and 468 slope towards each other and get closer near the top 464. This allows the fasteners to become latched together even when they are brought near each other in imperfect alignment. This slight slope also allows some slight amount of force applied along the X axis to be transferred to the Z axis. This also makes unlatching the latch somewhat easier, because the force does not have to be applied perfectly along the Z axis.

FIGS. 6B-6F are an end views of various possible ridge structures for male fasteners of a magnetic latch, according to illustrative embodiments. For each ridge structure shown in FIGS. 6B-6F, a corresponding trench structure can accommodate the side and shape of the ridge. FIG. 6B shows a possible ridge structure with the top and sidewalls arranged approximately 90 degrees from each other. The ridge 610 can make a latch more secure than other ridges. No force applied along the X axis can be transferred to the Z axis. This 90 degree alignment makes the latch harder to separate, and therefore capable of holding heavier weights.

FIG. 6C shows a possible ridge structure with a shorter ridge. The shorter ridge 620 can make fasteners easier to separate, because they only need to be pulled in the Z direction the distance of the height of the ridge 620, and then the fasteners can be shifted in the X direction. FIG. 6D shows a possible ridge structure with a taller ridge. The taller ridge 630 can make the fasteners harder to separate, and can prevent a slight bump or minor impact from overcoming the lateral motion restrictor. FIG. 6E shows a possible ridge structure with a triangular cross section. The sloped sides of the triangular cross-section ridge 640 makes the latch easier to align into engagement and easier to separate. FIG. 6F shows a possible ridge structure with a curved or semicircular cross section. The curved sides of the curved ridge 650 make the latch even easier to separate without having to apply force directly along the Z axis. It should be clear that in various embodiments, various shapes and sizes of ridges and trenches are possible, and that various shapes and sizes of ridges and trenches may have different benefits in different applications.

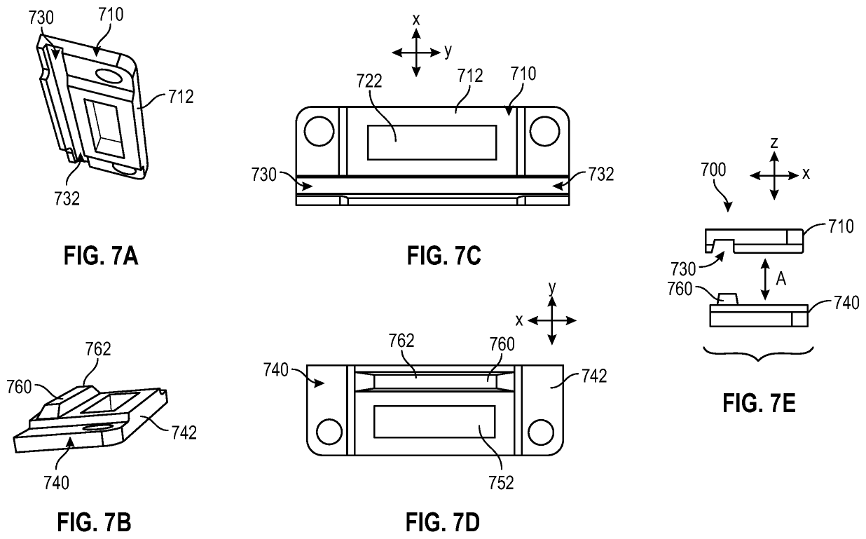

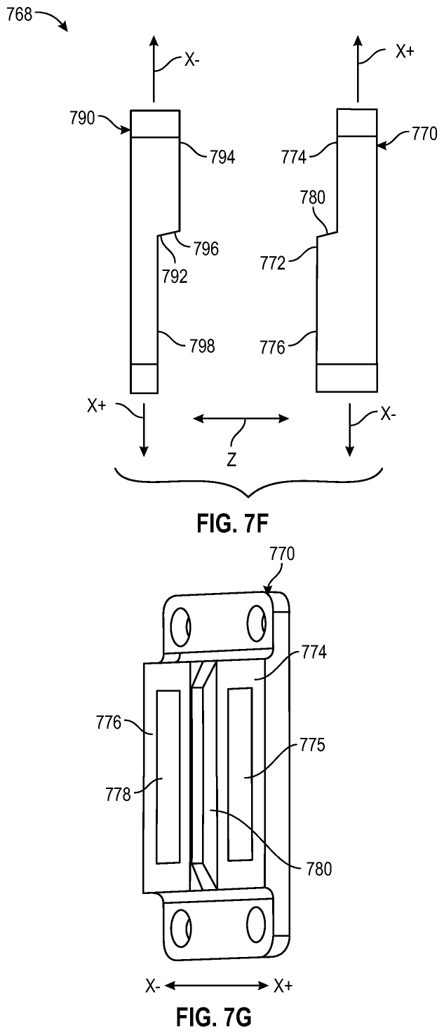

FIG. 7A is a perspective view of a female fastener of a magnetic latch with a single magnet, according to an illustrative embodiment. In various embodiments, a female fastener 710 may have a fastener body 712 adapted to have a single magnet for engaging with a male fastener. Fastener body 712 can have a lateral motion restrictor 730 such as female trench 732. FIG. 7B is a perspective view of a male fastener of a magnetic latch with a single magnet, according to an illustrative embodiment. In various embodiments, a male fastener 740 may have a fastener body 742 adapted to have a single magnet for engaging with a female fastener. Fastener body 742 can have a lateral motion restrictor 760 such as male ridge 762. Various numbers of magnets are specifically contemplated, and embodiments with more than two magnets are discussed more fully below.

FIG. 7C is a top view of a female fastener of a magnetic latch with a single magnet, according to an illustrative embodiment, and FIG. 7D is a top view of a male fastener of a magnetic latch with a single magnet, according to an illustrative embodiment. The female fastener 710 can have a female trench 732 and magnet 722, and the male fastener can have a male ridge 762 and magnet 752. The male ridge 762 can extend above the magnet face 744, and the female trench 732 can extend below the magnet face 714. The ridge 762 and trench 732 allow the male fastener and female fastener to slide laterally in the Y direction when the latch is latched in the engaged conformation, but the ridge 762 and trench 732 do not allow the male and female fasteners to become separated in the X direction when the latch is latched in the engaged conformation. That is to say, the lateral motion restrictors restrict motion along the X axis, but the lateral motion restrictors do not restrict motion along the Y axis. Although the attractive force between magnets can constrain motion along the Y axis, the lateral motions restrictors may not restrict motion along the Y axis.

FIG. 7E is an exploded end view of the magnetic latch of FIGS. 7A and 7B, showing the male fastener and the female fastener in position to become engaged by moving in the Z direction; according to an illustrative embodiment; When the female fastener and male fastener are brought close to each other, the magnets attract each other and the fasteners can move towards each other along arrow A. When the latch is in the latched conformation, which is to say, when the male fastener and female fastener have been brought together so they are in engagement, the lateral motion restrictors prevent the male and female fasteners from being separated in the X direction, and the attractive force of the magnets resists the male and female fasteners being separated in the Z direction. It should be clear that the lateral motion restrictors restrict motion along the X axis, but the lateral motion restrictors may not restrict motion along the Z axis. Although the attractive force between magnets can constrain motion along the Z axis, the lateral motions restrictors may not restrict motion along the Z axis. In various embodiments, latch 700 may have one magnet on each fastener, or each fastener can have multiple magnets lined up along the same side of the lateral motion restrictor.

FIG. 7F is an exploded end view of a magnetic latch with X+ lateral motion inhibitors, according to an illustrative embodiment, and FIG. 7G is a perspective view of a fastener shown in FIG. 7F with an X+ lateral motion inhibitor, according to an illustrative embodiment. A magnetic latch 768 with X+ lateral motion inhibitors can have a first fastener 770 and a second fastener 790. The first fastener 770 can have a X+ lateral motion inhibitor 772 that can be raised above a lowered magnet face 774 of the first fastener 770, so that the first fastener has a lowered magnet 776 in the lowered magnet face 774 below the X+ lateral motion inhibitor 772. The second fastener 790 can have a lateral motion inhibitor 792 that can be approximately the same level as or lower than a raised magnet face 794 of the second fastener 790.

Put another way, the first X+ lateral motion inhibitor 772 of the first fastener 770 can include a first opposition wall 780 that extends upwards from the lower magnet face 774. In various embodiments, the first opposition wall 780 can extend upwards from the lowered magnet face 774 at an angle that can be in a range between approximately 60° and approximately 120°. In various embodiments, the first opposition wall 780 can extend upwards from the lowered magnet face 774 at an angle that can be in a range between approximately 75° and approximately 105°. The second X+ lateral motion inhibitor 792 of the second fastener 790 can include a second opposition wall 796 that can extend downwards from the raised magnet face 794. In various embodiments, the second opposition wall 796 can extend downwards from the raised magnet face 794 at an angle that can be in a range between approximately 60° and approximately 120°. In various embodiments, the second opposition wall 796 can extend downwards from the raised magnet face 794 at an angle that can be in a range between approximately 75° and approximately 105°. The first opposition wall 780 of the first fastener 770 can run parallel with and lie alongside the lower magnet 776 in the lower magnet face 774, and the second opposition wall 796 of the second fastener 790 can run parallel with and lie alongside the magnet in the raised magnet face 794.

When the first fastener 770 and the second fastener 790 are in engagement with each other, the lower magnet face 774 can be in engagement with the raised magnet face 794 and the first opposition wall 780 can be in abutment with the second opposition wall 796. When the first fastener 770 and the second fastener 790 are in engagement with each other, they can be pulled apart along the Z axis, or they can be slid apart along the Y axis, or they can be slid apart in the direction of the arrows marked X−. The opposition walls prevent the first and second fasteners from being slid apart in the direction of the arrows marked X+, unless the first and second fasteners are first pulled apart along the Z axis until they are separated enough so that the opposition walls are no longer in abutment with each other.

This magnetic latch with the X+ lateral motion inhibitor allows the first fastener and the second fastener to be separated in the direction of the arrows marked X-much more easily than they can be separated in the direction of the arrows marked X+. As shown in FIG. 7F, when the magnetic latch is in engagement, the fasteners can be separated more easily by sliding them along their respective X− arrows relative to each other, but the X+ lateral motion inhibitor inhibits motion of the fasteners in their respective X+ directions relative to each other. This X+ lateral motion inhibitor allows for heavy objects to be suspended using the magnetic latch, while also allowing for the heavy object to be removed, that is, allows for the first and second fasteners to be separated, without having to separate the first and second fasteners along the Z or Y axes. Instead, the suspended object and its attached fastener can be lifted off of the other fastener in the X− direction.

By way of non-limiting example, the first fastener 770 can be attached to a wall or other supporting surface in such a direction so that the X− arrow of the first fastener arrow points in the same direction as the pull of gravity. A heavy object, or other object to be suspended, can then be attached to the second fastener 790, and the second fastener 790 can be placed in engagement with the first fastener 770. Because the X+ lateral motion inhibitor inhibits the second fastener 790 from moving in its X+ direction relative to the first fastener 770, the object can remain suspended. However, because the X+ lateral motion inhibitor does not inhibit motion in the X− direction, the magnetic latch can be opened by lifting the object and the second fastener 790 in the X− direction.

In various embodiments, the first fastener 770 may also have an optional raised magnet face 776 with a raised magnet 778, so that the raised magnet face can be approximately as high or higher than the X+ lateral motion inhibitor. In various embodiments, the second fastener 790 may have an optional lowered magnet face 798 that can be approximately as low or lower than the X+ lateral motion inhibitor. These optional raised magnet face 776 on the first fastener 770 and lowered magnet face on the second fastener 790 can increase the holding power or the magnetic latch. That is to say, these optional raised magnet face 776 on the first fastener 770 and lowered magnet face 798 on the second fastener 790 can increase the magnetic attractive force holding the first fastener and second fastener together along the X− direction, the Y axis, and especially the Z-axis.

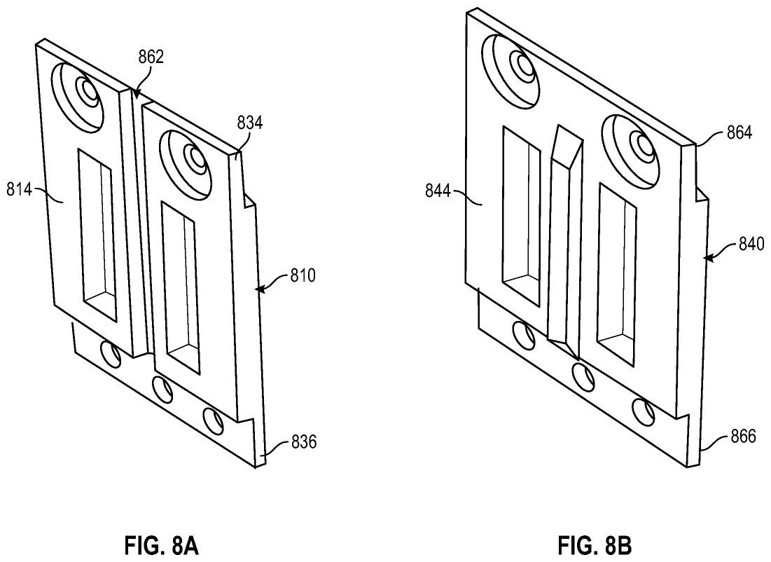

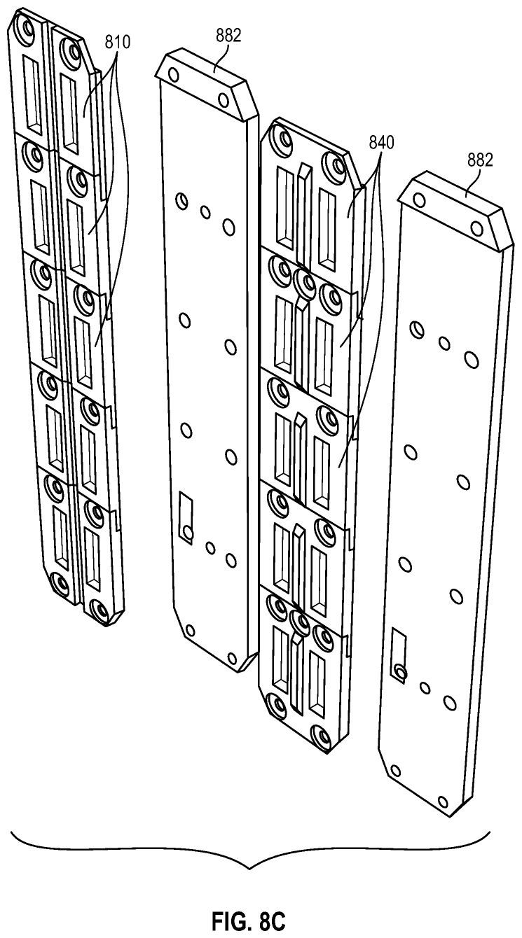

FIG. 8A is a perspective view of a female fastener of a modular magnetic latch, according to an illustrative embodiment, and FIG. 8B is a perspective view of a modular male fastener unit of a modular magnetic latch, according to an illustrative embodiment. Multiple modular female fastener units 810 can be connected together in series, and multiple modular male fastener units 840 can be connected together in series. Modular female fastener unit 810 can have a tall connecting end 834 and a low connecting end 836. The low connecting end 836 of one modular female fastener unit can fit under, and be connected with, the tall connecting end 834 of a neighboring modular female fastener. In various embodiments, the upper surface of the tall connecting end 834 can be in the same plane as the magnet face 814. The trench 862 can extend through the tall connecting end 834. Similarly, modular male fastener unit 840 can have a tall connecting end 864 and a low connecting end 866. The low connecting end 866 of one modular male fastener unit can fit under, and be connected with, the tall connecting end 864 of a neighboring modular male fastener unit. In various embodiments, the upper surface of the tall connecting end 864 can be in the same plane as the magnet face 844. Multiple fastener units can be connected together to create a latch that can carry more weight than a latch with a single pair of fastener units. Multiple fastener units can also be connected together to create a latch that has a greater range of latching positions than a latch with single fastener units. By way of non-limiting example, a long flap on a pouch can have multiple fastener units together so that the flap can be stretched around oversized objects sticking out of the pouch, and the flap can be latched into an extended range of possible latching positions.

FIG. 8C is an exploded perspective view of a modular latch, according to an illustrative embodiment. A modular latch 800 can include one or more support boards 882. One or more modular female fastener units 810 can be attached to a support board 882 to create a single, one-piece modular female fastener. Similarly, one or more modular male fastener units 840 can be attached to a support board 882 to create a single, one-piece modular male fastener.

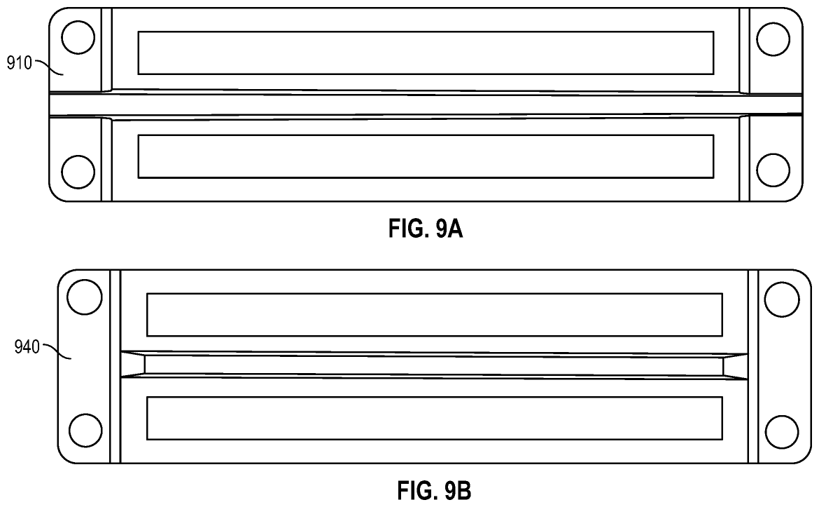

FIG. 9A is a top view of an elongated female fastener 910 of a magnetic latch, according to an illustrative embodiment, and FIG. 9B is a top view of an elongated male fastener 940 of a magnetic latch, according to an illustrative embodiment. Various fasteners can be various lengths and widths, and various fasteners can incorporate various magnets with various pull strengths. Extending the length of the fastener to incorporate longer magnets can increase the holding strength, or the weight the latch can hold. On the other hand, decreasing the length of the fastener can allow a latch to be useful in smaller areas. Various lengths and shapes of fasteners are possible, and can be useful in different applications.

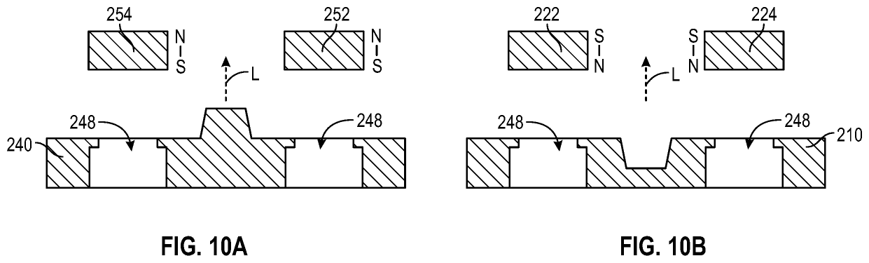

FIG. 10A is an exploded cross section view of the male fastener shown in FIG. 3B, taken along cross section line 10A-10A showing magnets in position to be installed from above, according to an illustrative embodiment, and FIG. 10B is an exploded cross section view of the female fastener shown in FIG. 3A, taken along cross section line 10B-10B, showing magnets in position to be installed from above, according to an illustrative embodiment. In various embodiments, a magnet well 246 can extend downward into the fastener body and can be sized and shaped to hold magnets. In embodiments with magnets installed from above, the magnet surface can be flush with the magnet face of the fastener when the magnet is fully installed. The magnets can be held in place in the magnet well using various adhesives. The male fastener can have the magnets installed so that the N pole is exposed in the latching direction, with the N pole facing in the direction of arrow L. As used herein, latching direction can mean in the direction that will be facing the female latch when the male latch and female latch are being brought into engagement, such as FIG. 4. The male fastener can have the magnets installed so that the S pole is facing away from the latching direction. Put another way, the magnet can be installed so that the S pole is facing away from the female fastener when the male fastener and female fastener are being brought into engagement, as shown in FIG. 4. The female fastener can have the magnets installed so that the S pole is exposed in the latching direction, with the S pole facing in the direction of arrow L. As used herein, latching direction can mean in the direction that will be facing the male latch when the male latch and female latch are being brought into engagement, such as FIG. 4. The female fastener can have the magnets installed so that the N pole is facing away from the latching direction. Put another way, the magnet can be installed so that the N pole is facing away from the male fastener when the male fastener and female fastener are being brought into engagement, as shown in FIG. 4. FIG. 10C is a bottom view of a fastener shown in FIG. 3A with the magnets installed from the top, according to an illustrative embodiment. A fastener 210 with the magnets installed from the top can have a smooth back 284. Although the fastener shown in FIG. 10C is labeled as female fastener 210, it should be clear that the female fastener and the male fastener can look the same from the back 284.

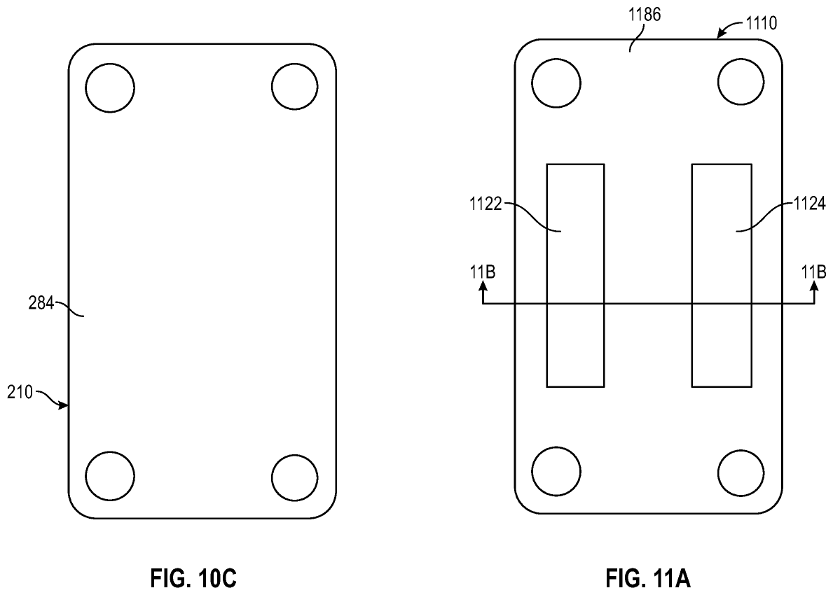

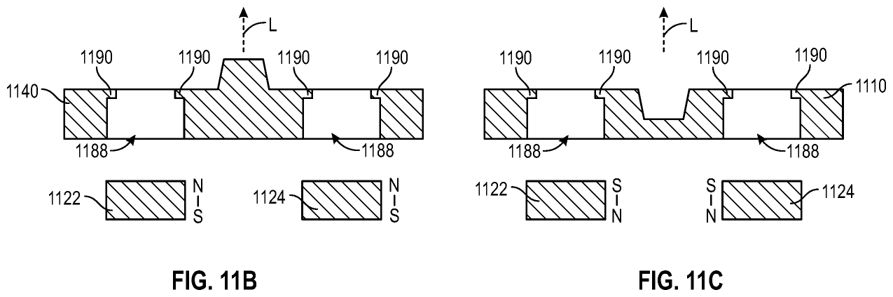

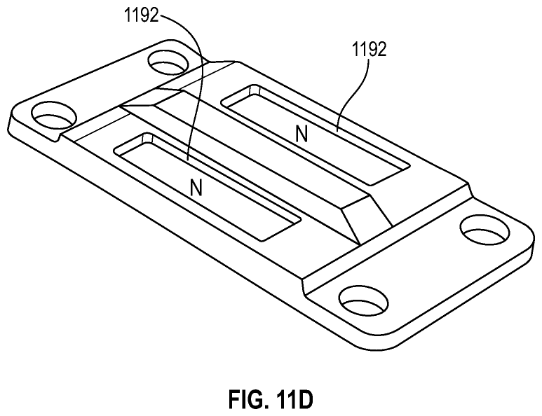

FIG. 11A is a bottom view of a fastener with the magnets installed from the bottom, according to an illustrative embodiment. Fastener 1110 can have a back 1186 with magnet wells that open to the back to accommodate magnets 1122 and 1124. It should be clear that male fasteners and female fasteners can look the same from the back 1186.

FIG. 11B is an exploded cross section view of a male fastener 1140, taken along cross section line 11B-11B of FIG. 11A, showing magnets in position to be installed from below, according to an illustrative embodiment, and FIG. 11C is an exploded cross section view of a female fastener 1110, taken along cross section line 11B-11B of FIG. 11A, showing magnets in position to be installed from below, according to an illustrative embodiment. In various embodiments, a magnet well 288 can extend upward from the back into the fastener body and can be sized and shaped to hold magnets 1122 and 1124. In embodiments with magnets installed from the back, a lip 1190 can prevent the magnet from being pulled out of the top of the fastener. Put another way, in embodiments with magnets installed from the back, lip 1190 can form a bezel that can prevent the magnet from being pulled upward out of the magnet face. The male fastener can have the magnets installed so that the N pole is exposed in the latching direction, with the N pole facing in the direction of arrow L. As used herein, latching direction can mean in the direction that will be facing the female latch when the male latch and female latch are being brought into engagement, such as FIG. 4. The male fastener can have the magnets installed so that the S pole is facing away from the latching direction. Put another way, the magnet can be installed so that the S pole is facing away from the female fastener when the male fastener and female fastener are being brought into engagement, as shown in FIG. 4. The female fastener can have the magnets installed so that the S pole is exposed in the latching direction, with the S pole facing in the direction of arrow L. As used herein, latching direction can mean in the direction that will be facing the male latch when the male latch and female latch are being brought into engagement, such as FIG. 4. The female fastener can have the magnets installed so that the N pole is facing away from the latching direction. Put another way, the magnet can be installed so that the N pole is facing away from the male fastener when the male fastener and female fastener are being brought into engagement, as shown in FIG. 4. FIG. 11D is a perspective view of the top of a male fastener with a bezel holding in a magnet that was installed from the back, according to an illustrative embodiment. The male fastener has the magnet arranged with the N pole facing upwards through the bezel. Turning to FIGS. 11B, 11C, and 11D, lip 1190 can form a bezel 1192 that at least partially lines the upper end of the magnet well 1188. The bezel can restrain the magnet from pulling out of the magnet face.

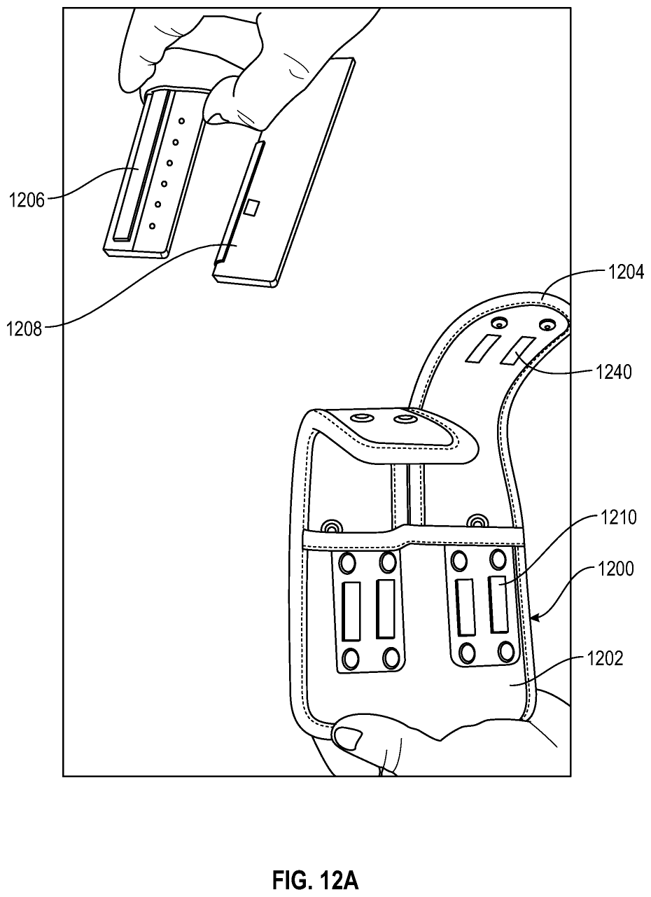

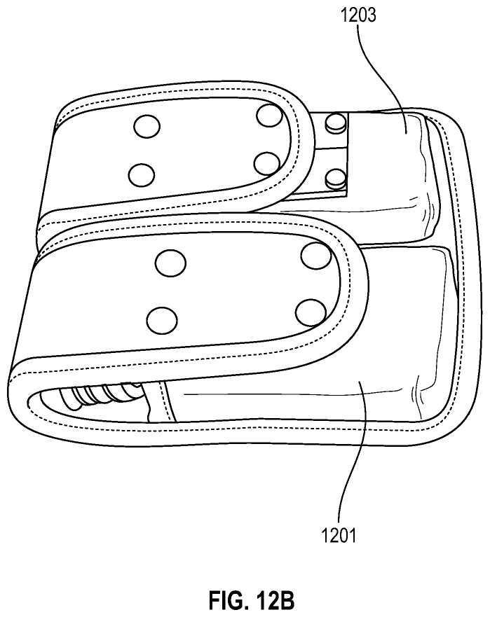

FIG. 12A is a perspective view of magnetic latches installed on storage pouches for use on a belt, according to an illustrative embodiment. Each pouch 1200 can have a female fastener 1210 on the pouch body 1202, and a male fastener 1240 on the pouch flap 1204. It should be clear that the pouch body could have a male fastener and the pouch flap could have a female fastener, so long as a latch includes both a female fastener and a male fastener. A first elongated object 1206 can be inserted into one pouch and a second elongated object 1208 can be inserted into the other pouch. As shown in FIG. 12A, the second elongated object 1208 is longer than the first elongated object 1206.

FIG. 12B is a perspective view of the storage pouches of FIG. 12A, shown in a closed conformation, according to an illustrative embodiment. Turning to FIGS. 12A and 12B, the first pouch 1201 is holding the shorter elongated object, and the second pouch 1203 is holding the second elongated object 1208. The flap 1204 of the first pouch 1201 is pulled down farther onto the pouch body when compared to the flap 1204 of the second pouch 1203. The longer elongated object of in the second pouch prevents the flap from being pulled down as far. Fortunately, the latch system described herein allows both pouches to be securely latched, regardless of the size of the elongated object sticking out from the pouch. In the case of the second pouch 1203, the magnets of the male and female fasteners continue to attract each other, which causes the fasteners to be biased towards full engagement. When the fasteners are only in partial engagement, as shown on pouch 1203, they are pulling the flap tight as they pull towards each other. The fasteners described herein allow for a wide range of latching positions, and the fasteners will provide a biasing force that pulls the two fasteners together, tightening the latch and tightening the flap on the pouch. Unlike a prior art latch utilizing a snap, a single magnetic latch can be casually released somewhat close to alignment, and the latch will automatically latch itself and pull itself into the tightest position it can. Unlike prior art latches, the latch is silent to open. A user can grasp the flap and open the latch without the sound of Velcro ripping open, snaps unsnapping, etc.

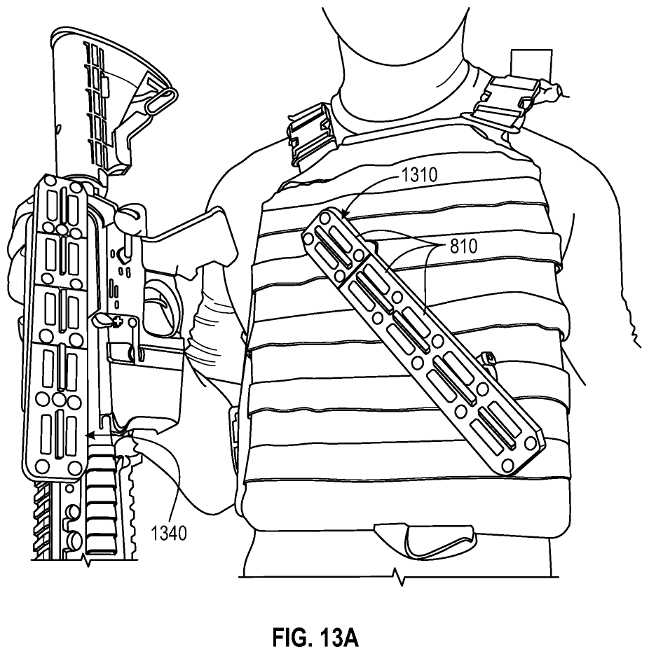

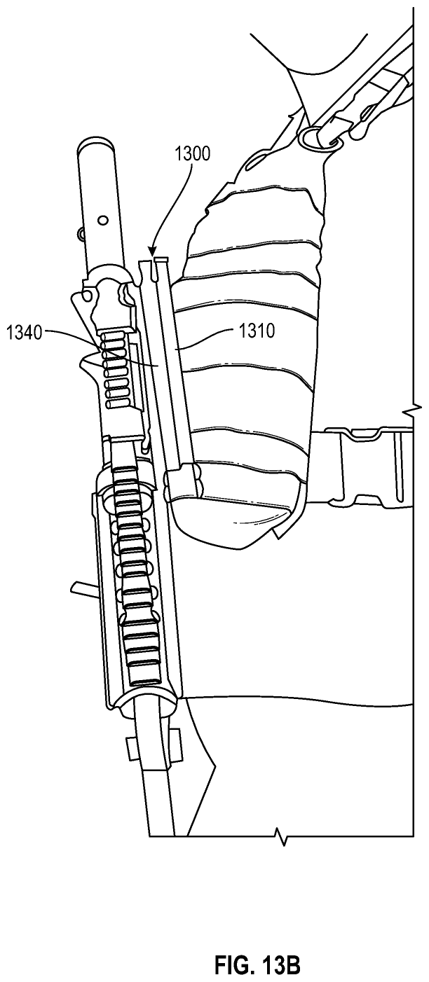

FIG. 13A is a perspective view of a modular latch in use in a military application for supporting a weapon on the chest of a user, according to an illustrative embodiment. A modular fastener 1310 can include any number of modular fastener units 810. Connecting multiple modular fastener units 810 together can create a latch that can hold heavier weights than a latch with single fastener units. As shown in FIG. 13A, a female modular fastener 1310 can be held on the chest of the user, and a male modular fastener 1340 can be mounted to a user's weapon. FIG. 13B is a perspective view of the latch of FIG. 13A being used to hold the weapon without a strap, according to an illustrative embodiment. By incorporating multiple fastener units together into a single modular fastener, a latch 1300 can support a significant amount of weight safely. The strong attraction in the Z direction keeps the lateral motion restrictors in constant engagement, which then allows the lateral motion restrictors to assist in supporting the suspended weight. The lateral motion restrictors restrict motion in the X direction, which means they can effectively support the weight in the X direction. A user can quickly grasp the weapon and pull it away from the chest, easily separating the fasteners when required. The weapon is then easily handheld, without the need for a strap that can get tangled with other equipment.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, in various embodiments, In various embodiments, the lateral motion restrictors can be multiple ridges and trenches, or various other grooves, tabs, or other means to restrict lateral motion. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 1-2%) of the system. Note also, as used herein the terms “process” and/or “processor” should be taken broadly to include a variety of electronic hardware and/or software based functions and components. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

What is claimed is:

1. A magnetic latch comprising:
a male fastener, the male fastener comprising a first lateral motion restrictor and at least one magnet, the at least one magnet having a first pole exposed in a latching direction and a second pole facing away from a latching direction, and
a female fastener, the female fastener comprising a second lateral motion restrictor and at least one magnet, the at least one magnet having a second pole exposed in a latching direction and a first pole facing away from a latching direction.

2. The magnetic latch of claim 1, wherein the first lateral motion restrictor is an elongated ridge that rises upwards relative to the at least one magnet of the male fastener and extends parallel to the at least one magnet of the male fastener, and wherein the second lateral motion restrictor is an elongated trench that is sunken downwards relative to the at least one magnet of the female fastener and extends parallel to the at least one magnet of the female fastener.

3. The magnetic latch of claim 1, wherein the at least one magnet of the male fastener further comprises at least two magnets, wherein a first one of the at least two magnets is on a first side of the first lateral motion restrictor and a second one of the at least two magnets is on a second side of the first lateral motion restrictor, and wherein the at least one magnet of the female fastener further comprises at least two magnets, wherein a first one of the at least two magnets is on a first side of the second lateral motion restrictor and a second one of the at least two magnets is on a second side of the second lateral motion restrictor.

4. The magnetic latch of claim 1, wherein the second lateral motion restrictor is an elongated trench that extends through the entire length of the female fastener.

5. The magnetic latch of claim 1, wherein when the male fastener and the female fastener are in engagement with each other, the male fastener and the female fastener cannot move relative to each other in the direction of an X axis, and the male fastener and the female fastener can move relative to each other in the direction of a Y axis and a Z axis.

6. The magnetic latch of claim 1, wherein when the male fastener and the female fastener are in engagement with each other, the first lateral motion restrictor and the second lateral motion restrictor are in engagement with each other.

7. The magnetic latch of claim 6, wherein when the first lateral motion restrictor and the second lateral motion restrictor are in engagement with each other, the first lateral motion restrictor and the second lateral motion restrictor restrict movement of the male fastener and the female fastener relative to each other in the direction of the X axis, and wherein when the first lateral motion restrictor and the second lateral motion restrictor are in engagement with each other, the first lateral motion restrictor and the second lateral motion restrictor do not restrict the movement of the male fastener and the female fastener relative to each other in the direction of the Y axis and Z axis.

8. A method of using a magnetic latch comprising:
placing a male fastener close to a female fastener, wherein the male fastener has a first lateral motion restrictor and at least one magnet, the at least one magnet having a first pole exposed in a latching direction and a second pole facing away from the latching direction, the first lateral motion restrictor having a lengthwise axis, and wherein the female fastener has a second lateral motion restrictor and at least one magnet, the at least one magnet having a second pole exposed in a latching direction and a first pole facing away from a latching direction, the second lateral motion restrictor having a lengthwise axis; and
bringing the male fastener and female fastener closer together until they are in engagement.

9. The method of claim 8, further comprising aligning the first lateral motion restrictor and the second lateral motion restrictor so that they are approximately in the same plane before bringing the male fastener and the female fastener closer together until they are in alignment, and wherein bringing the male fastener and female fastener closer together until they are in engagement further comprises bringing the male fastener and female fastener closer together along the plane of the male fastener and the female fastener.

10. The method of claim 8, further comprising separating the male fastener and the female fastener by sliding them in a parallel unfastening direction that is parallel to, and in the same plane as the first lateral motion restrictor and the second lateral motion restrictor, so that the first lateral motion restrictor slides along the second lateral motion restrictor, wherein the lateral motion restrictor prevents the male fastener and the female fastener from sliding in restricted direction that is perpendicular to the plane of the first lateral motion restrictor and the second lateral motion restrictor.

11. The method of claim 8, further comprising separating the male fastener and the female fastener by pulling them in a perpendicular unfastening direction that is in the same plane as the first lateral motion restrictor and the second lateral motion restrictor, and perpendicular to the lengthwise axis of the first lateral motion restrictor and the lengthwise axis of the second lateral motion restrictor, so that the first lateral motion restrictor is pulled away from the second lateral motion restrictor, wherein the lateral motion restrictor prevents the male fastener and the female fastener from sliding in restricted direction that is perpendicular to the plane of the first lateral motion restrictor and the second lateral motion restrictor.

12. The method of claim 8, further comprising separating the male and female fastener, wherein separating the male and female fastener includes choosing between two different ways to pull the male and female fastener apart;
wherein the first way includes sliding the male and female fasteners in a parallel unfastening direction that is parallel to, and in the same plane as the first lateral motion restrictor and the second lateral motion restrictor, so that the first lateral motion restrictor slides along the second lateral motion restrictor, wherein the lateral motion restrictor prevents the male fastener and the female fastener from sliding in restricted direction that is perpendicular to the plane of the first lateral motion restrictor and the second lateral motion restrictor; and
wherein the second way includes pulling the male and female fasteners in a perpendicular unfastening direction that is in the same plane as the first lateral motion restrictor and the second lateral motion restrictor, and perpendicular to the lengthwise axis of the first lateral motion restrictor and the lengthwise axis of the second lateral motion restrictor, so that the first lateral motion restrictor is pulled away from the second lateral motion restrictor, wherein the lateral motion restrictor prevents the male fastener and the female fastener from sliding in restricted direction that is perpendicular to the plane of the first lateral motion restrictor and the second lateral motion restrictor.

13. The method of claim 8, further comprising applying a lateral load to the magnetic latch after the male and female fasteners are in engagement, wherein the lateral load provides a force in a restricted direction that is perpendicular to a plane that includes the lengthwise axis of the first lateral motion restrictor and the lengthwise axis of the second lateral motion restrictor, and wherein the first lateral motion restrictor and the second lateral motion restrictor restrict movement along the restricted direction, thereby supporting the lateral load.

14. The method of claim 13, further comprising separating the male fastener and the female fastener so that the male fastener and female fastener can move in the restricted direction relative to each other.

15. The method of claim 14, wherein separating the male and female fastener includes using at least one of two different ways to pull the male and female fastener apart,
wherein the first way includes sliding the male and female fasteners in a parallel unfastening direction that is parallel to, and in the same plane as the first lateral motion restrictor and the second lateral motion restrictor, so that the first lateral motion restrictor slides along the second lateral motion restrictor, wherein the lateral motion restrictor prevents the male fastener and the female fastener from sliding in restricted direction that is perpendicular to the plane of the first lateral motion restrictor and the second lateral motion restrictor, and
wherein the second way includes pulling the male and female fasteners in a perpendicular unfastening direction that is in the same plane as the first lateral motion restrictor and the second lateral motion restrictor, and perpendicular to the lengthwise axis of the first lateral motion restrictor and the lengthwise axis of the second lateral motion restrictor, so that the first lateral motion restrictor is pulled away from the second lateral motion restrictor, wherein the lateral motion restrictor prevents the male fastener and the female fastener from sliding in restricted direction that is perpendicular to the plane of the first lateral motion restrictor and the second lateral motion restrictor.

16. A method of separating a magnetic latch, the method comprising separating a female fastener and a male fastener, wherein the male fastener has a first lateral motion restrictor and at least one magnet, the at least one magnet having a first pole exposed in a latching direction and a second pole facing away from the latching direction, the first lateral motion restrictor having a lengthwise axis, and wherein the female fastener has a second lateral motion restrictor and at least one magnet, the at least one magnet having a second pole exposed in a latching direction and a first pole facing away from a latching direction, the second lateral motion restrictor having a lengthwise axis, wherein separating the magnetic latch includes separating the at least one magnet of the male fastener and the at least one magnet of the female fastener.

17. The method of claim 16, wherein separating the male and female fastener includes choosing at least one out of two different ways to pull the male and female fastener apart;
wherein the first way includes sliding the male and female fasteners in a parallel unfastening direction that is parallel to, and in the same plane as the first lateral motion restrictor and the second lateral motion restrictor, so that the first lateral motion restrictor slides along the second lateral motion restrictor, wherein the lateral motion restrictor prevents the male fastener and the female fastener from sliding in restricted direction that is perpendicular to the plane of the first lateral motion restrictor and the second lateral motion restrictor; and
wherein the second way includes pulling the male and female fasteners in a perpendicular unfastening direction that is in the same plane as the first lateral motion restrictor and the second lateral motion restrictor, and perpendicular to the lengthwise axis of the first lateral motion restrictor and the lengthwise axis of the second lateral motion restrictor, so that the first lateral motion restrictor is pulled away from the second lateral motion restrictor, wherein the lateral motion restrictor prevents the male fastener and the female fastener from sliding in restricted direction that is perpendicular to the plane of the first lateral motion restrictor and the second lateral motion restrictor.

18. The magnetic latch of claim 16, wherein separating the male fastener and the female fastener includes pulling them in a perpendicular unfastening direction that is in the same plane as the first lateral motion restrictor and the second lateral motion restrictor, and perpendicular to the lengthwise axis of the first lateral motion restrictor and the lengthwise axis of the second lateral motion restrictor, so that the first lateral motion restrictor is pulled away from the second lateral motion restrictor, wherein the lateral motion restrictor prevents the male fastener and the female fastener from sliding in restricted direction that is perpendicular to the plane of the first lateral motion restrictor and the second lateral motion restrictor.

19. The magnetic latch of claim 16, wherein separating the male fastener and the female fastener includes sliding them in a parallel unfastening direction that is parallel to, and in the same plane as the first lateral motion restrictor and the second lateral motion restrictor, so that the first lateral motion restrictor slides along the second lateral motion restrictor, wherein the lateral motion restrictor prevents the male fastener and the female fastener from sliding in restricted direction that is perpendicular to the plane of the first lateral motion restrictor and the second lateral motion restrictor.
